(19) United States
(12) Patent Application Publication
(10) Pub. No.: US 2018/0225420 A1
(43) Pub. Date: Aug. 9, 2018

(54) Medical Data Sharing in a Replicated Environment

(71) Applicant: Banyan Medical Systems, Inc., Omaha, NE (US)

(72) Inventors: Tony Buda, Waterloo, NE (US); Jeff Broz, Elkhorn, NE (US)

(21) Appl. No.: 15/429,015

(22) Filed: Feb. 9, 2017

(51) Int. Cl. G06F 19/00

(52) U.S. Cl. CPC G06F 19/3418; G06F 19/327; G06F 19/328; G06F 19/322

(57) ABSTRACT

A system for coordinating and facilitating communication and data sharing between healthcare providers and patients includes a computer system that establishes data communication with separate healthcare systems and monitoring instruments. Healthcare providers access all the separate healthcare systems and monitoring instruments from any local or remote client via a secure connection. The computer system establishes connections between two or more clients and clones a working environment from one client to the others. Each client recognizes and replicates any changes or inputs made in the working environment on every other client.

### FIELD OF THE INVENTION

Embodiments of the inventive concepts disclosed herein are directed generally toward data sharing in a medical environment, and more particularly toward a system for consolidating multiple data streams into a unified environment and replicating the unified environment to multiple clients.

### BACKGROUND

Coordinating medical care with patients and between care providers is highly cumbersome. Most systems utilized in providing care are independent; and even when different people have access to the same data, there is no way to coordinate and facilitate communication between those people remotely.

Accessing healthcare data from multiple independent systems is difficult because there is no unified system for accessing stored data and real-time data simultaneously. Furthermore, even when data is accessible, there is no facility to allow multiple healthcare providers to access data simultaneously.

Collaborating between healthcare professionals is cumbersome because simultaneous data access is difficult or impossible. Multiple healthcare providers have no facility for reviewing stored data and real-time data and providing insight in a collaborative way, in real-time.

Educating patients in their own treatment is problematic because there are no facilities for easily sharing information with the patient when the information is scattered across multiple independent systems. Furthermore, Patients are often frustrated by multiple healthcare professionals periodically providing snippets of sometimes contradictory information in multiple sessions, spread out over a long period of time.

Consequently, it would be advantageous if an apparatus existed that is suitable for coordinating and facilitating collaborative communication, education, and data access between healthcare providers and patients.

### SUMMARY

In one aspect, embodiments of the inventive concepts disclosed herein are directed to coordinating and facilitating communication and data sharing between healthcare providers and patients. A computer system is configured to establish data communication with a plurality of separate healthcare systems and a plurality of monitoring instruments. Healthcare providers may access all the separate healthcare systems and monitoring instruments from any local or remote client via a secure connection.

In a further aspect, the computer system may establish connections between two or more clients and clone a working environment from one client to the others. Each client recognizes and replicates any changes or inputs made in the working environment on every other client.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1A shows a block diagram of a system implementing embodiments of the inventive concepts disclosed herein;

FIG. 1B shows a block diagram of a system implementing embodiments of the inventive concepts disclosed herein;

FIG. 1C shows a block diagram of a system implementing embodiments of the inventive concepts disclosed herein;

FIG. 1D shows a block diagram of a system implementing embodiments of the inventive concepts disclosed herein;

FIG. 1E shows a block diagram of a system implementing embodiments of the inventive concepts disclosed herein;

FIG. 2A shows a block diagram of a network of connections according to the inventive concepts disclosed herein;

FIG. 2B shows a block diagram of a network of connections according to the inventive concepts disclosed herein;

FIG. 3 shows a representation of a client terminal according to embodiments of the inventive concepts disclosed herein;

FIG. 4 shows a representation of a client terminal according to embodiments of the inventive concepts disclosed herein;

FIG. 5 shows a representation of a system for replicating client terminals according to embodiments of the inventive concepts disclosed herein;

FIG. 6A shows a representation of a client terminal according to embodiments of the inventive concepts disclosed herein;

FIG. 6B shows a representation of a client terminal according to embodiments of the inventive concepts disclosed herein;

FIG. 6C shows a representation of a client terminal according to embodiments of the inventive concepts disclosed herein;

FIG. 7 shows a block diagram of a system configured to implement the inventive concepts disclosed herein;

FIG. 8 shows a flowchart of a method for replicating a working environment according to the inventive concepts disclosed herein; and

FIG. 9 shows a flowchart of a method for coordinating hospital assets according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to coordinating and facilitating communication and data sharing between healthcare providers and patients. A computer system is configured to establish data communication with a plurality of separate healthcare systems and a plurality of monitoring instruments. Healthcare providers may access all the separate healthcare systems and monitoring instruments from any local or remote client via a secure connection.

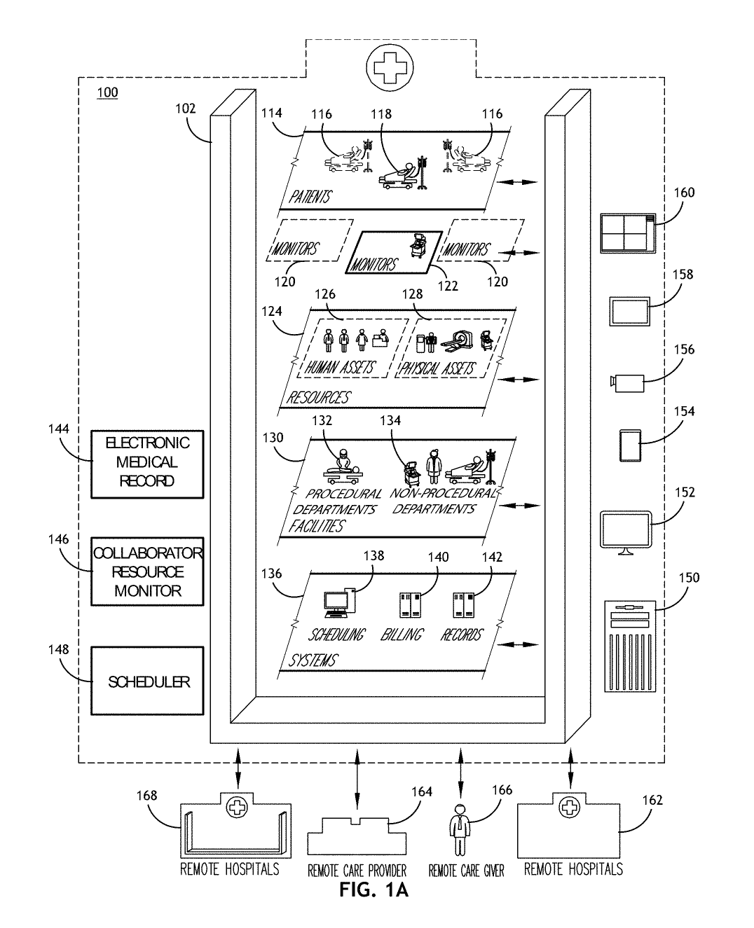

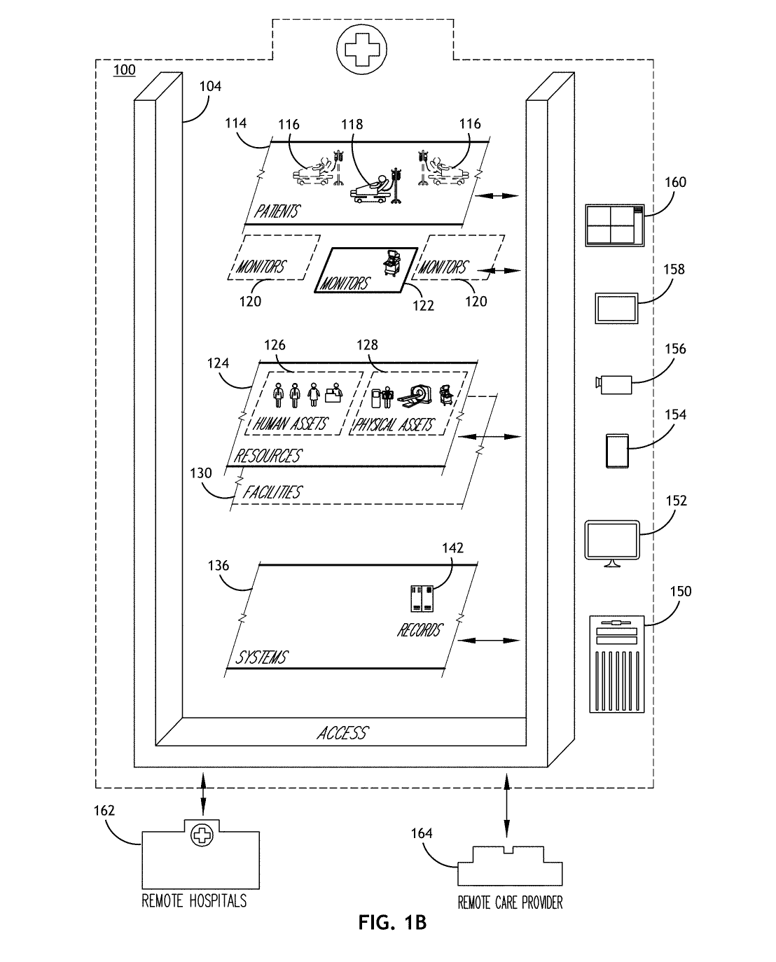

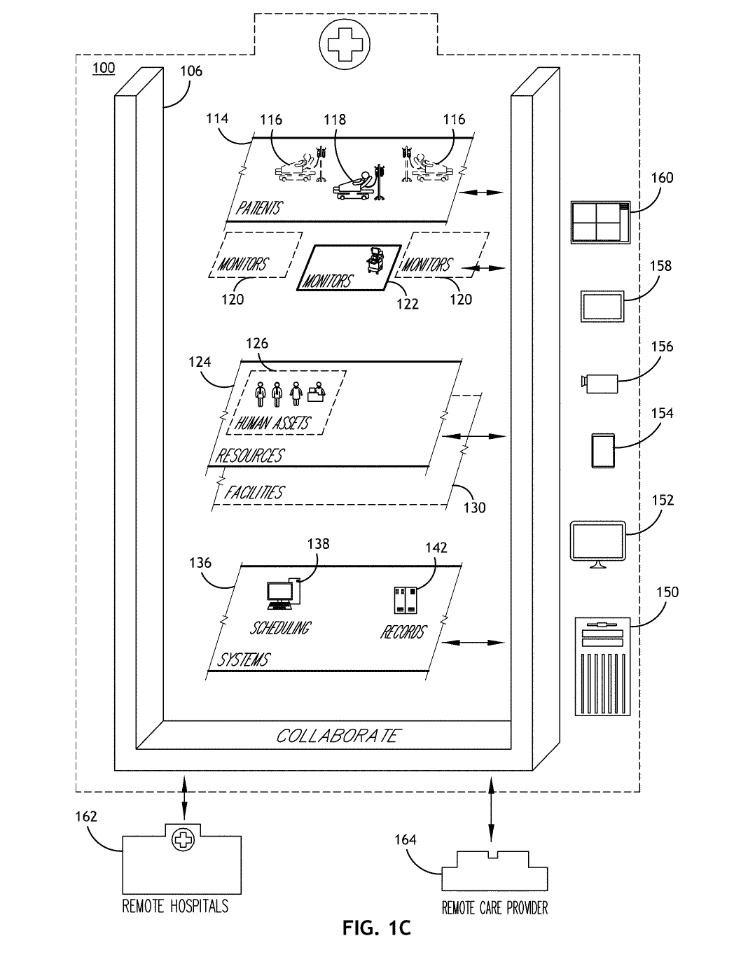

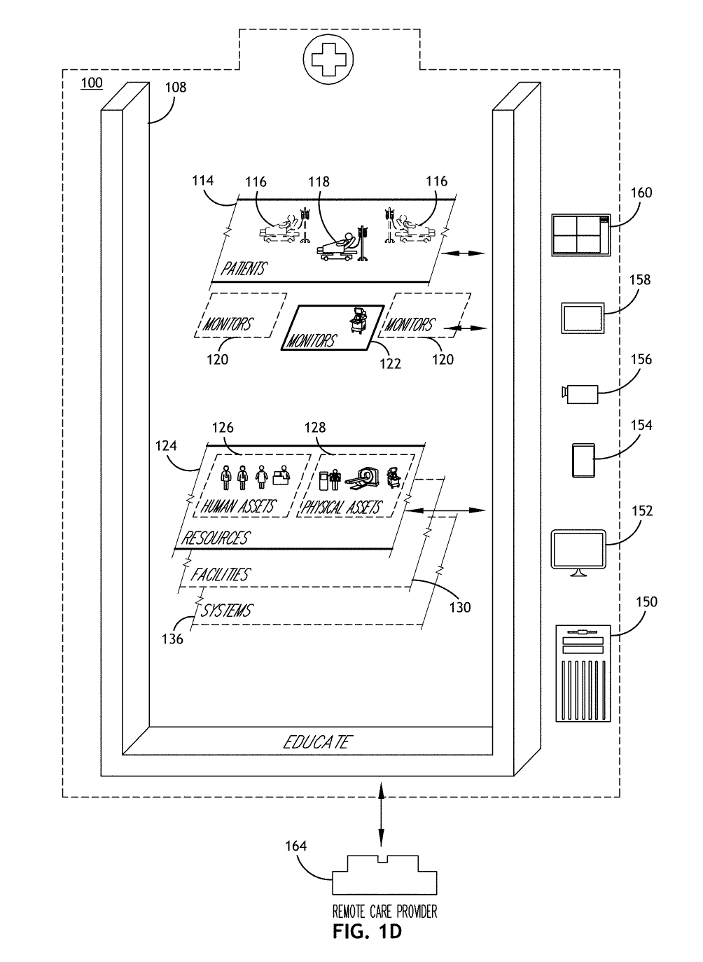

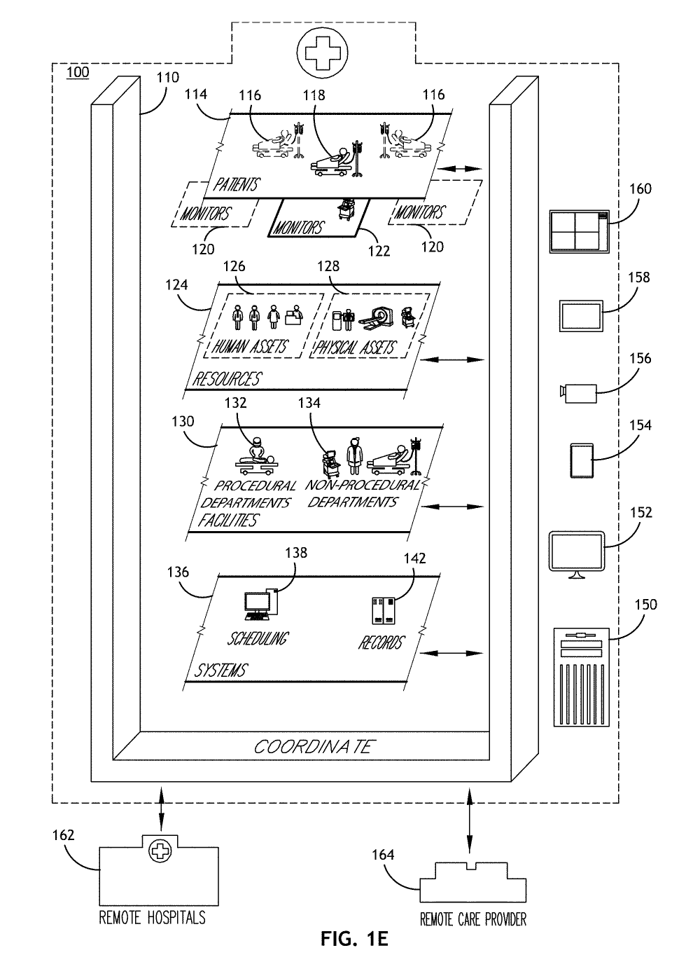

Referring to FIGS. 1A-1E, block diagrams of several implementations of the inventive concepts disclosed herein are shown. Each block diagram represents a different use case of the same system in a hospital 100 or other healthcare facility. Referring to FIG. 1A, a hospital 100 includes a server 102 defining a plurality of functional domains 114, 120, 122, 124, 130, 136.

A patient domain 114 includes every connected patient 116, 118 (such as through a client terminal in each patients 116, 118 room). The server 102 allows access to each patient 116, 118. Such access may include security features such as data encryption, even between the server 102 and any client devices attempting such access, or user authentication. Furthermore, each patient 116, 118 client terminal may be designated as a slave device, allowing every healthcare provider client computer 150 to assume control.

A monitor domain 120, 122 may be associated with each patient 116, 118 in the patient domain 114; each monitor domain 120, 122 including data access protocols to physical monitoring equipment currently connected to the corresponding patient 116, 118. The server 102 allows access to each monitor domain 120, 122, again including the possibility of data encryption and authentication.

A resource domain 120, 122 allows server 102 access to relevant human assets through direct messaging, video conferencing, or other such communication applications, or to segregated data specifically associated with a human asset; and physical assets such as diagnostic machines. Human assets and physical assets may be segregated into a human assets subdomain 126 and a physical assets subdomain 128. Access may be restricted based on data encryption and authentication.

A facilities domain 130 allows server 102 access defined facility subsets such as procedural departments 132 and all of the assets currently assigned to the procedural departments 132, or non-procedural departments 134 and all of the assets currently assigned to the non-procedural departments 134. Procedural departments 132 and assets may include, but are not limited to, procedural specialists, surgical cameras, angiographic imaging devices, hemodynamic monitors, and endoscopes. Likewise, non-procedural departments 134 and assets may include, but are not limited to, non-procedural specialists, mobile diagnostic devices, and in-room cameras. The facilities domain 130 may also define historical sets of facilities 132, 134 and corresponding assets to facilitate searching and correlating patient data associated with a facility 132, 134 at a previous time. Access may be restricted based on data encryption and authentication.

A systems domain 136 allows server 102 access to administrative systems 138, 140, 142 within the hospital 100 such as a scheduling system 138, a billing system 140, and a hospital record system 142. Each system 138, 140, 142 may include plugins to facilitate data communication with the server 102.

The server 102 may have access to read and alter a patient's electronic medical record 144 (EMR). The server 102 may be configured to add data from each domain 114, 120, 122, 124, 130, 136 to the patient EMR 144 and allow direct access to the patient EMR 144 by appropriate assets within each domain 114, 120, 122, 124, 130, 136. Furthermore, the server 102 may include a collaborator resource monitor 146 to monitor which assets, domains 114, 120, 122, 124, 130, 136, or other resources are being accessed by a healthcare provider at any given time, including tagging particular resource allocations with an identifier corresponding to a collaborating healthcare provider such that any collaborations added to the patient EMR 144 or electronic medical record are associated with the healthcare provider. Furthermore, the server 102 may utilize available data to format notes added the EMR 144 in SOAP format. Electronically adding notes in real-time or near real-time may prevent fraudulent copying forward. Likewise, the server 102 may include a scheduler 148 for organizing collaborative communication among healthcare providers and patients. In some embodiments, the sever 102 may communicate with multiple department specific schedulers 148 to identify availability of collaborators from different departments.

The server 102 may be in data communication with any of a number of client devices 150, 152, 154, 156, 158, 160. Client devices 150, 152, 154, 156, 158, 160 may include (but are not limited to) client computers 150, data enabled displays 152, smart phones 154, data enabled cameras 156, tablets 158, and dedicated display devices 160 such as signage. The server 102 facilitates or otherwise provides a data pipeline among client devices 150, 152, 154, 156, 158, 160 and assets within any domain 114, 120, 122, 124, 130, 136 provided the relevant security requirements are satisfied. In some embodiments, data traffic is routed through the server 102; alternatively, some data traffic may be facilitated by the server 102 which establishes a client-to-client connection by performing any authentication tasks, but otherwise does not participate in the data communication.

In addition, the server 102 may establish data communications with remote hospitals 162 or other healthcare facilities, with remote healthcare providers 164 or other remote care givers 166 such as family members, and with remote servers in enabled hospitals 168 where the remote servers are configured similarly to servers 102, 104, 106, 108, 110 described herein. The server 102 may authenticate all remote connections from remote hospitals 162 and remote healthcare providers 164, and facilitate connections to one or more client devices 150, 152, 154, 156, 158, 160, or one or more domains 114, 120, 122, 124, 130, 136. A connection between the server 102 and a remote server in an enabled hospital 168 may include specialized data connections to allow client devices 150, 152, 154, 156, 158, 160 access to the remote server, and assets connected to the remote server, as though they were locally connected. Devices may be members of more than one functional domain 114, 120, 122, 124, 130, 136 based on the functions of the device.

In some embodiments, communications between all client devices 150, 152, 154, 156, 158, 160 and domains 114, 120, 122, 124, 130, 136 may utilize Health Level-7 protocols and standards, such as Clinical Object Workgroup (CCOW) or Digital Imaging and Communications in Medicine (DICOM).

Data from client device 150, 152, 154, 156, 158, 160, or the client devices 150, 152, 154, 156, 158, 160 themselves, may be tagged with patient 116, 118 identifiers or other metrics. Similar tags may also be added to EMRs 144 to facilitate searching.

Referring to FIG. 1B, a block diagram of a system as described in FIG. 1A, including a server 104 configured for accessing client devices 150, 152, 154, 156, 158, 160 and assets within domains 114, 120, 122, 124, 130, 136 is shown. The server 104 specifically facilitates access to an active patient 118, patient monitors within the associated monitor domain 122 and assets associated with the active patient 118. Generally, access is envisioned as specific to the active patient 118; therefore, a healthcare provider attempting to access client devices 150, 152, 154, 156, 158, 160 or assets within domains 114, 120, 122, 124, 130, 136 may select an active patient 118. The server 104 then isolates client devices 150, 152, 154, 156, 158, 160 and assets within domains 114, 122, 124, 136 that are specifically flagged as corresponding to the active patient 118. Furthermore, the server 104 may identify records in remote hospitals 162 or remote healthcare providers 164 associated with the active patient 118, and establish access to those remote healthcare providers 164 and remote hospitals 162.

Alternatively, remote healthcare providers 164 or healthcare providers in remote hospitals 162 may acquire access to client devices 150, 152, 154, 156, 158, 160 and assets within domains 114, 122, 124, 136 associated with the active patient 118. The server 104 would provide authentication and a data pipeline for all of the remote healthcare providers 164 and healthcare providers in remote hospitals 162.

Referring to FIG. 1C, a block diagram of a system as described in FIG. 1A, including a server 106 configured for collaborative communication between healthcare providers is shown. The server 106 establishes a link between two or more client devices 150, 152, 154, 156, 158, 160 associated with a collaborating healthcare provider. The server 106 facilitates access for each collaborating healthcare provider to other client devices 150, 152, 154, 156, 158, 160 and assets in domains 114, 122, 124, 136 associated with an active patient 118. Generally, collaboration is envisioned as specific to the active patient 118; therefore, access to client devices 150, 152, 154, 156, 158, 160 or assets within domains 114, 120, 122, 124, 130, 136 may limit access to those that are specifically flagged as corresponding to the active patient 118. Furthermore, the server 106 may identify records in remote hospitals 162 or remote healthcare providers 164 associated with the active patient 118, and establish access to those remote healthcare providers 164 and remote hospitals 162.

The server 106 may establish one or more dedicated data connections between the collaborating healthcare providers. In some embodiments, one of the dedicated data connections may be dedicated for video communication. In some embodiments, the server 106 may establish a working environment based on a client computer 150 associated with one of the collaborating healthcare providers, and replicate the working environment on all of the client computers 150 of all the collaborating healthcare providers. Similarly, each client computer 150 identifies any changes to displayed data instituted by the healthcare provider and replicates those changes to every other healthcare provider client computer 150.

Client applications, especially those executing on mobile devices, may be configured to alter the replicated working environment to conform to screen size restrictions.

The server 106 may, if necessary, access a scheduling system 138 to establish a time for collaboration among the relevant healthcare providers.

Referring to FIG. 1D, a block diagram of a system as described in FIG. 1A, including a server 108 configured for educating a patient 116, 118. The server 108 specifically facilitates educating an active patient 118 through real-time interactions with one or more healthcare providers connected to the server 108 via a client computer 150, or any other human assets via any client device 150, 152, 154, 156, 158, 160. The one or more healthcare providers utilize records, monitors in a corresponding monitor domain 122, resources in a resources domain 124, input from other client devices 150, 152, 154, 156, 158, 160, and remote healthcare providers 164 accessible to the server 108 as described herein.

The server 108 may establish one or more dedicated data connections between the educating healthcare providers and the active patient 118. In some embodiments, one of the dedicated data connections may be dedicated for video communication. In some embodiments, the server 108 may establish a working environment based on a client computer 150 associated with one of the educating healthcare providers, and replicate the working environment on all of the client computers 150 of all the educating healthcare providers and the active patient 118. Similarly, each client computer 150 identifies any changes to displayed data instituted by a healthcare provider or active patient 118, and replicates those changes to every other client computer 150.

Client applications, especially those executing on mobile devices, may be configured to alter the replicated working environment to conform to screen size restrictions.

Referring to FIG. 1E, a block diagram of a system as described in FIG. 1A, including a server 110 configured for coordinating hospital 100 resources is shown. Patients 116, 118 are often frustrated by redundancy in hospitals 100 caused by a need for each healthcare provider to have certain information coupled with an inability to share information between healthcare providers. The server 110 facilitates coordination between healthcare providers by allowing real-time synchronization of data collected by each healthcare provider via a corresponding client device 150, 152, 154, 156, 158, 160.

Generally, such coordination is envisioned as specific to an active patient 118; therefore, data synchronization may be limited to client devices 150, 152, 154, 156, 158, 160 specifically associated with the active patient 118 or corresponding to healthcare providers specifically associated with the active patient 118. Furthermore, the server 110 may synchronize data with a record system 142 or other administrative systems in the systems domain 136 or any facilities 132, 134 in the facilities domain 130 associated with the active patient 118. Coordination may involve both historic data access from IT systems such as EMRs and real-time data from patient monitors or diagnostic machines.

In some embodiments, a healthcare provider may send a request to the server 110 for a specific human asset such as a scribe or an individual responsible for scheduling. The server 110 then identifies one such available human asset and connects them to the healthcare provider's client computer 150.

In some embodiments, individual healthcare providers may utilize server 110 functionality for increased specialization. For example, some doctors may be dedicated to performing rounds, freeing surgeons for more productive surgical endeavors; or, by connecting a scribe to a doctor on rounds via the doctors tablet 158, the doctor may be freed from entering notes in the EMR.

In some embodiments, the server 110 may track the time each collaborator was actually involved in a collaboration and automatically send such data to a billing system 140.

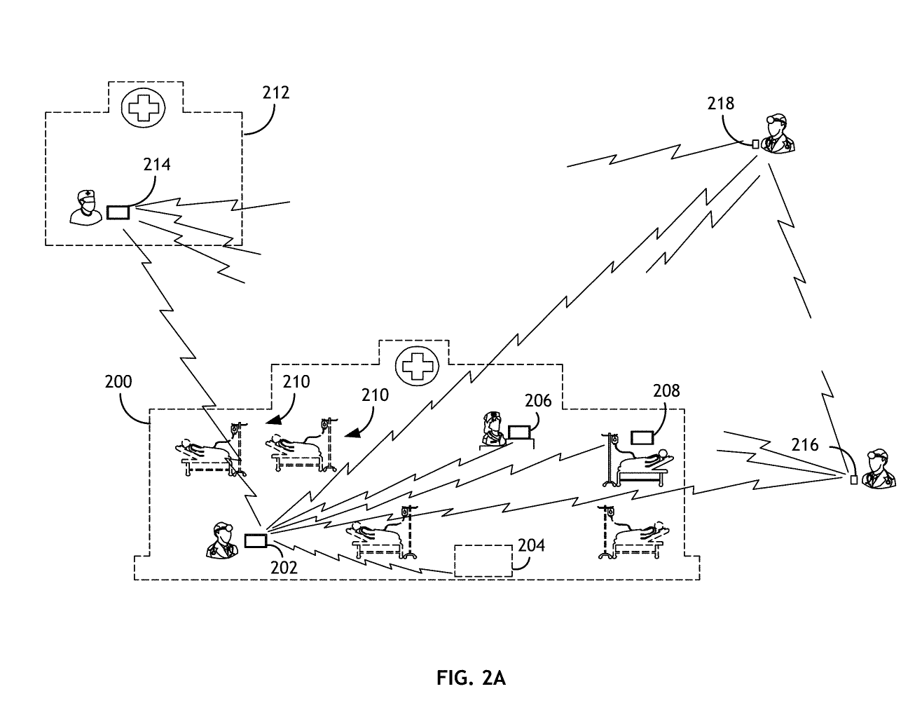

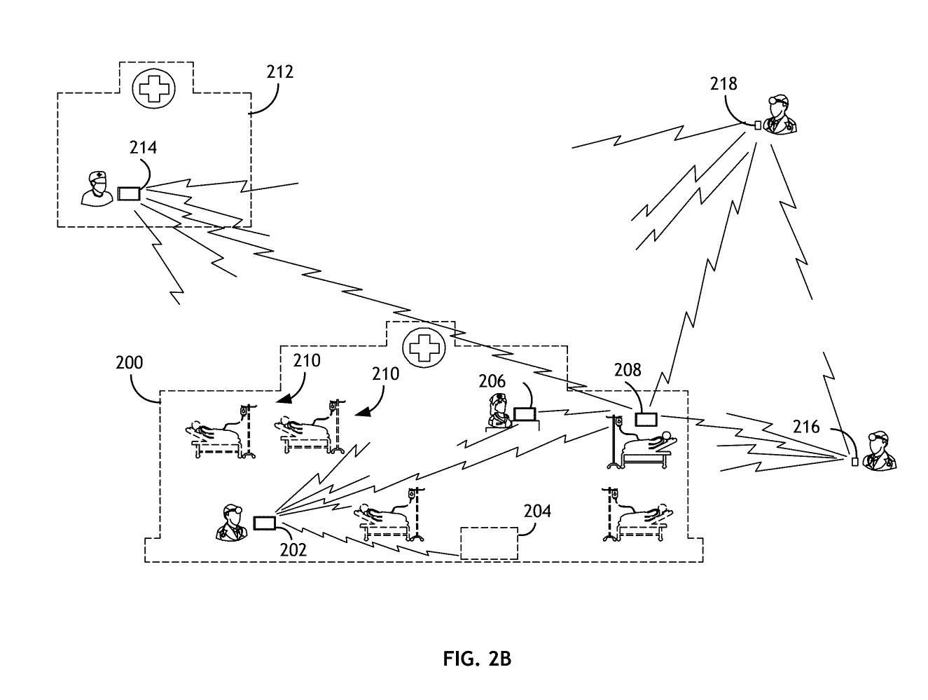

Referring to FIGS. 2A-2B, block diagrams of a network of connections according to the inventive concepts disclosed herein are shown. A hospital 200 including a system according embodiments of the inventive disclosures described herein may include a plurality of patients 210, one or more networked computer systems 204 such as a scheduling system and a record system, and a plurality of client devices 202-206, 208.

System connections at any given time may be specific to the application and the primary user. For example, as in FIG. 2A, where a healthcare provider accesses the system via a client computer 202, the client computer 202 has access to the one or more networked computer systems 204, a nurse's station 206, and a patient in-room terminal 208. Such connections may be instigated via a system server which then allows direct client-to-client communication; or all communication may be processed by the server. The client computer 202 may also access a remote client computer 214 in a remote hospital 212. Similarly, the client computer 202 may access one or more remote mobile client devices 216, 218, such as smart phones or tablet.

In another example, as in FIG. 2B, where a patient accesses the system via a patient in-room terminal 208, the in-room terminal 202 has access to a healthcare provider via the healthcare provider's client computer 202. The healthcare provider's client computer 202 may also access the one or more networked computer systems 204. The in-room terminal 202 may further access the nurse's station 206. Such connections may be instigated via a system server which then allows direct client-to-client communication; or all communication may be processed by the server. The in-room terminal computer 208 may also access a remote client computer 214 in a remote hospital 212. Similarly, the in-room terminal computer 208 may access one or more remote mobile client devices 216, 218, such as smart phones or tablet. In such an embodiment, one or more healthcare providers may collaborate with the patient and replicate a viewing environment amongst all the client devices 202, 206, 208, 214, 216, 218.

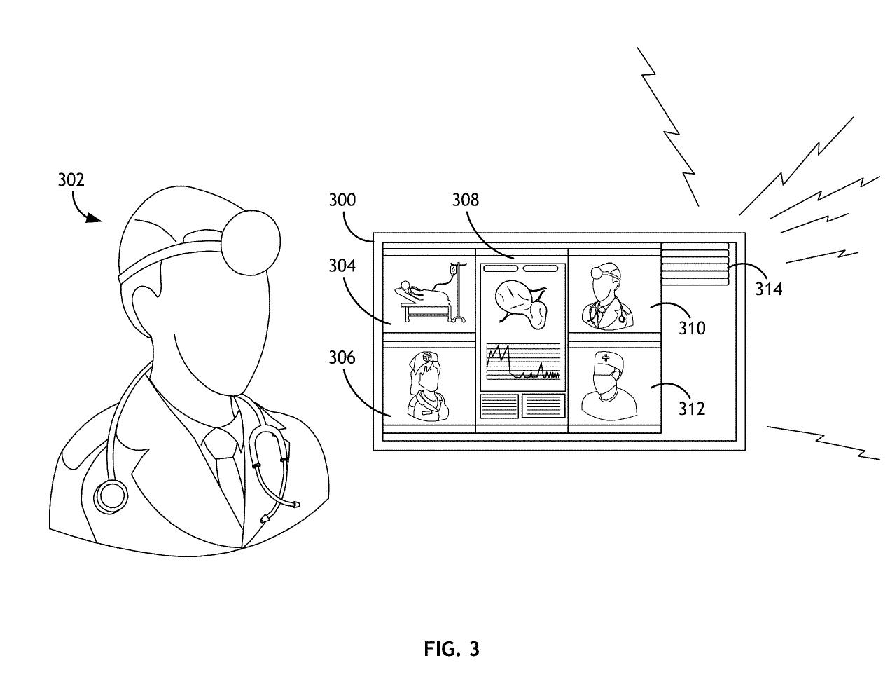

Referring to FIG. 3, a representation of a client terminal 300 according to embodiments of the inventive concepts disclosed herein is shown. The client terminal 300 allows a healthcare provider 302 a workspace with one screen access to a plurality of patient information portals 304, 306, 308, 310, 312. Each patient information portal 304, 306, 308, 310, 312 corresponds to a separate client device, data repository, patient monitoring device, or the like. The client terminal 300 may also include a selectable list 314 of alternative workspaces. Each of the alternative workspaces may correspond to a separate patient, a separate collaboration task involving a plurality of healthcare providers, or otherwise separate role based tasks.

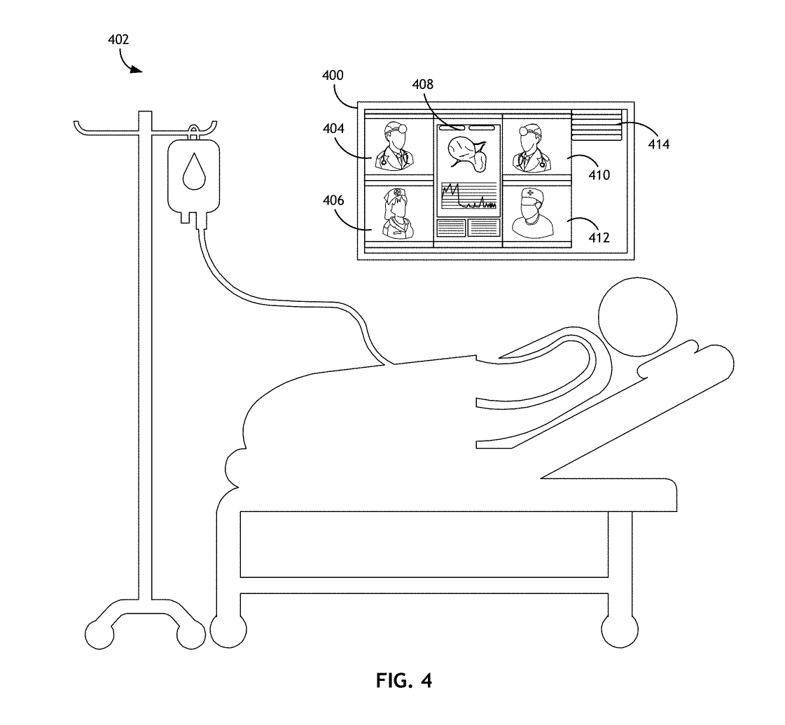

Similarly, referring to FIG. 4, a representation of a patient client terminal 400 according to embodiments of the inventive concepts disclosed herein is shown. The patient client terminal 400 allows a patient 402 a workspace with one screen access to a plurality of healthcare providers 404, 406, 410, 412 and patient information portals 408. In some embodiments, workspace may be replicated from a corresponding healthcare provider client terminal. The patient client terminal 400 may also include a selectable list 414 of alternative workspaces. Each of the alternative workspaces may correspond to a workspace of a specific healthcare provider 404, 406, 410, 412.

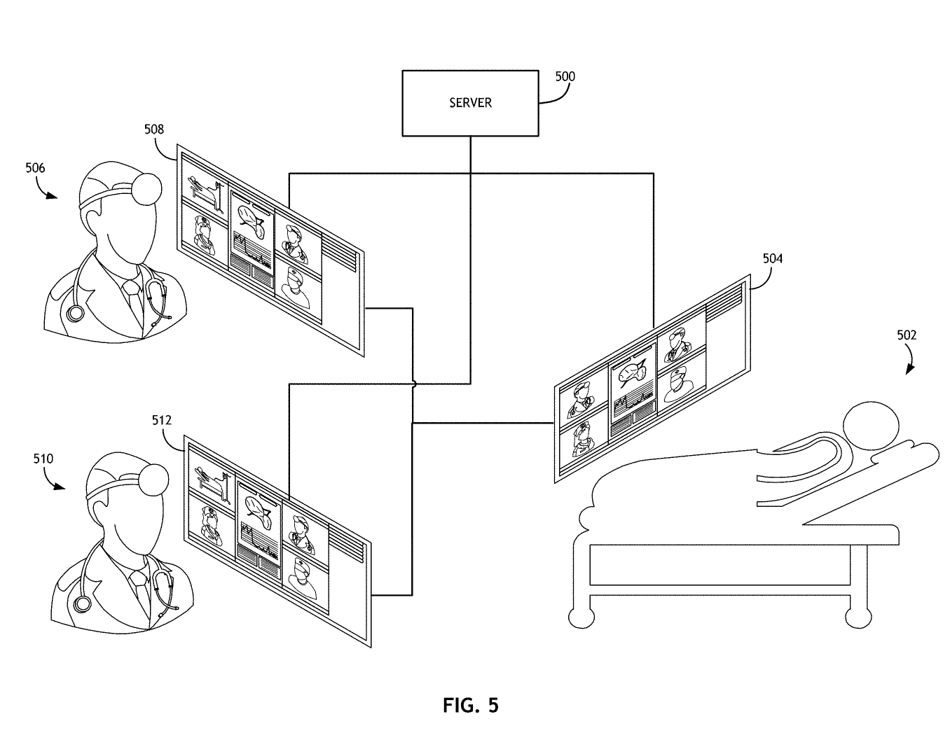

Referring to FIG. 5, a representation of a system for replicating client terminals 504, 508, 512 among a patient 500 and one or more healthcare providers 506, 510 according to embodiments of the inventive concepts disclosed herein is shown. The system includes a server 500 in data communication with each of the client terminal 504, 508, 512. In one embodiment, all communications are routed through the server 500. Any alteration to the replicated workspace in any client terminal 504, 508, 512 is recognized by the server 500 and replicated in every other client terminal 504, 508, 512. Alterations may include displaying new data, opening new client information portals, annotating any displayed information, or the like. In another embodiment, the server 500 establishes an initial communication pipeline between all client terminals 504, 508, 512 and designates one workspace as the replicated workspace. After the initial setup, each client terminal 504, 508, 512 may communicate with every other client terminal 504, 508, 512 directly without intervention by the server 500.

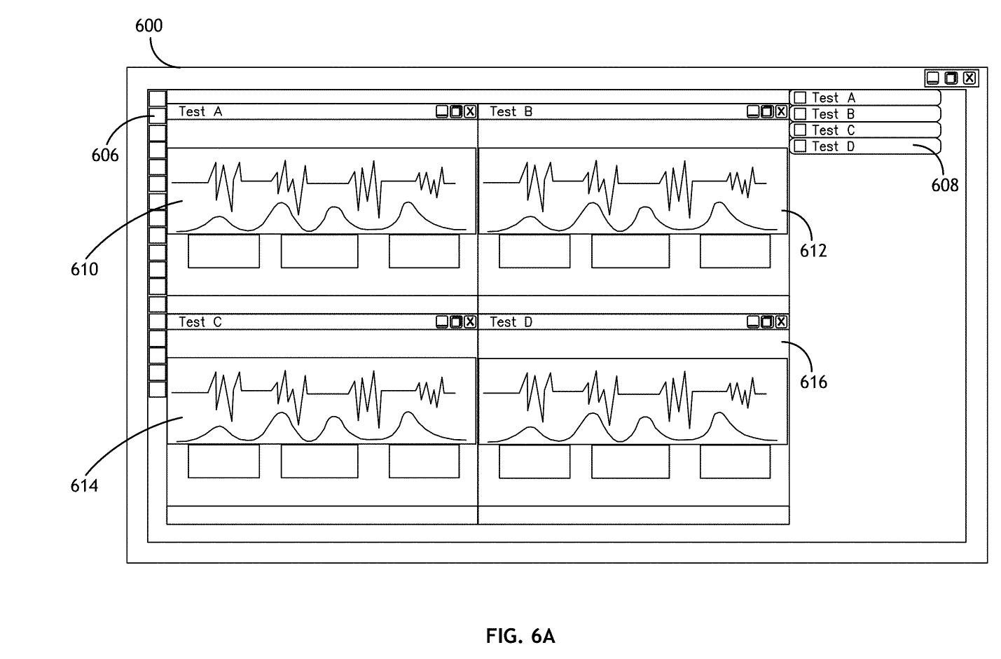

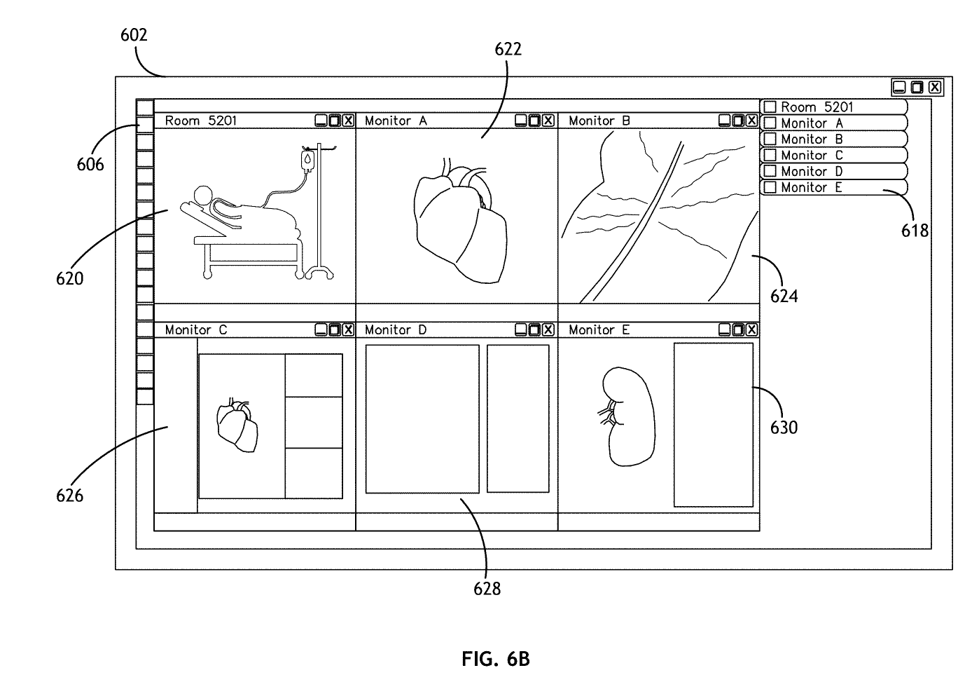

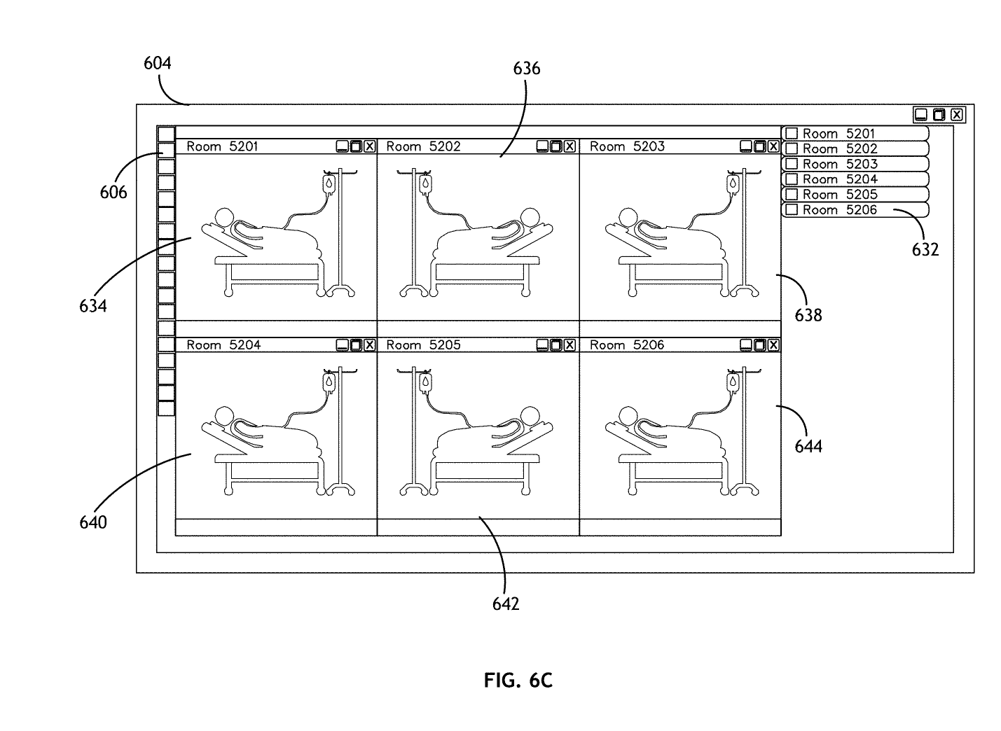

Referring to FIGS. 6A-6C, representations of client terminals 600, 602, 604 according to embodiments of the inventive concepts disclosed herein are shown. In one embodiment, such as in FIG. 6A, a client terminal 600 includes a workspace allowing access to a plurality of applications 606 that may be embodied in separate hospital systems, Each separate hospital system may include a plugin to facilitate data communication and interaction with a centralized server according to embodiments of the inventive concepts disclosed herein. The workspace displays a plurality of patient information portals 610, 612, 614, 616, each potentially drawing from separate data storage devices, patient monitoring devices, or diagnostic devices. The workspace may also include a selectable list 608 of patient information portals 610, 612, 614, 616 for selecting which patient information portals 610, 612, 614, 616 should be included in a replicated workspace when collaborating with healthcare providers.

In another embodiment, such as in FIG. 6B, a client terminal 602 includes a workspace displaying a plurality of patient information portals 620, 622, 624, 626, 628, 630 associated with a particular patient. Each patient information portal 620, 622, 624, 626, 628, 630 may be associated with a separate data storage device, patient monitoring device, or diagnostic device. The workspace may also include a selectable list 618 of patient information portals 620, 622, 624, 626, 628, 630 for selecting which patient information portals 620, 622, 624, 626, 628, 630 should be included in a replicated workspace when collaborating with healthcare providers.

In another embodiment, such as in FIG. 6C, a client terminal 604 includes a workspace displaying a plurality of patient monitoring portals 634, 636, 638, 640, 642, 644 associated with a particular patient. Each patient information portal 620, 622, 624, 626, 628, 630 may be associated with a separate patient camera or other patient monitoring device. The workspace may also include a selectable list 632 of patient monitoring portals 634, 636, 638, 640, 642, 644 for selecting which patient monitoring portals 634, 636, 638, 640, 642, 644 should be included in a replicated workspace when collaborating with healthcare providers.

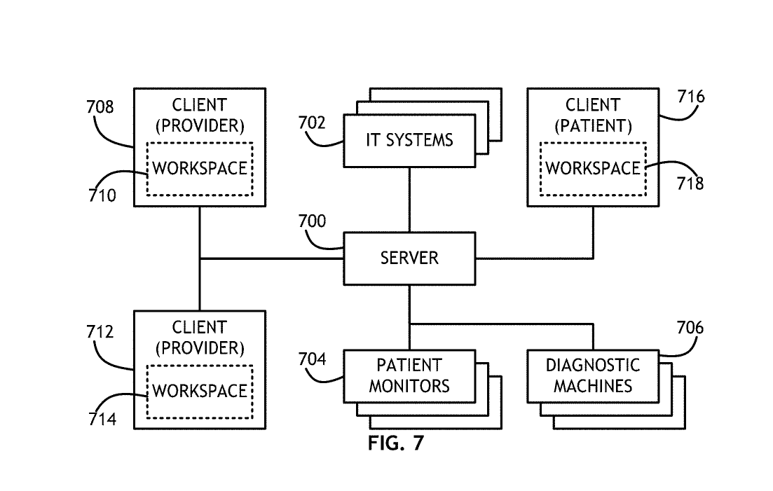

Referring to FIG. 7, a block diagram of a system configured to implement the inventive concepts disclosed herein is shown. The system includes a server 700 configured to connect to a plurality of information technology (IT) systems 702 within a hospital. IT systems 702 include, but are not limited to, local EMRs, remote or regional EMRs, private practice management systems, picture archiving and communication systems (PACS) imaging, popHealth software, decision support images, and reference libraries such as educational content and pharmacology references. Each IT system 702 may include a plugin application where necessary to facilitate interaction the server 700. The server 700 is also configured to connect to a plurality of patient monitors 704 such as vital sign monitoring devices and diagnostic machines 706 such as ultra sound machines, each configured to provide patient specific information to the server 700. A healthcare provider client 708, 712 connected to the server 700 may access data from the plurality of patient monitors 704, diagnostic machines 706, and IT systems 702. Each healthcare provider client 708, 712 may produce a workspace 710, 714 for consolidating all selected data into viewing portals that may be organized within the workspace 710, 714. In some embodiments, either the server 700 or the healthcare provider clients 708, 712 may replicate a first workspace 710 in a second workspace 714 such that any changes are synchronized between the workspaces 710, 714.

The system may also include one or more patient clients 718. In such a system, the replicated first workspace 710 may also be replicated to a patient workspace 718.

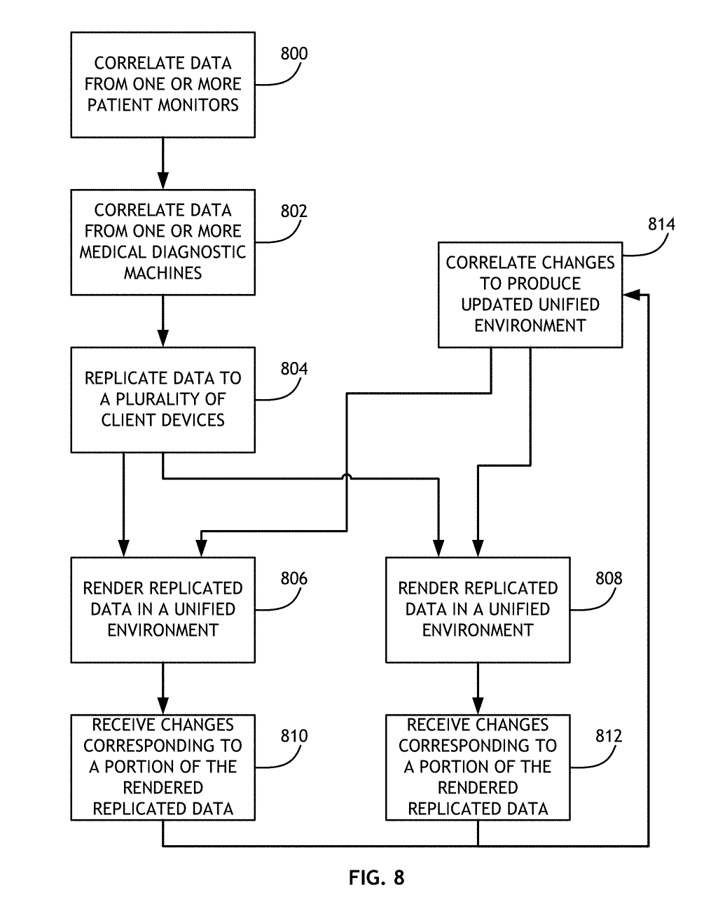

Referring to FIG. 8, a flowchart of a method for replicating a working environment according to the inventive concepts disclosed herein is shown. A server device correlates 800 data from one or more patient monitors and may also correlate 802 data from one or more medical diagnostic machines. The server then replicates 804 such data to a plurality of client devices. In one embodiment, a first client device defines the workspace to be replicated; the server identifies the workspace to be replicated and constructs a unified virtual environment according to the identified workspace. The server then instructs each client to render 806, 808 the replicated data in the unified environment.

Each client may receive 810, 812 a change corresponding to a portion of rendered replicated data such as an annotation. In one embodiment, each client sends the received changes to the server which correlates 814 the changes to produce an updated unified environment which is then sent to and rendered 806, 808 by each client. Alternatively, each client may send identified changes to every other client. Each client then independently correlates 814 the changes to produce and render 806, 808 the updated unified environment.

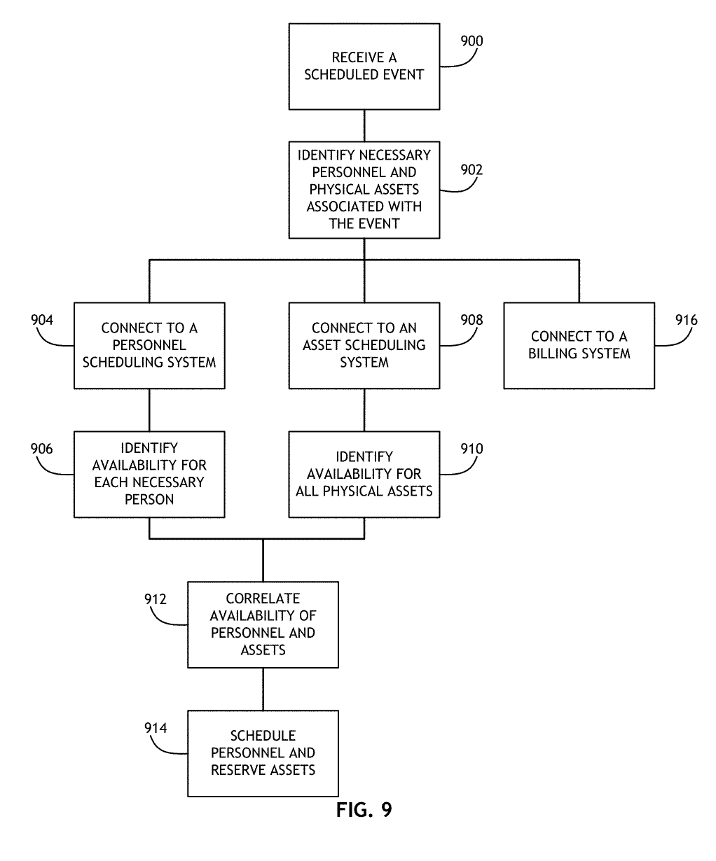

Referring to FIG. 9, a flowchart of a method for coordinating hospital assets according to the inventive concepts disclosed herein is shown. A server system receives 900 a scheduled event and identifies 902 assets necessary for the scheduled event. The server system may identify an independent hospital system useful for managing the allocation of different classes of assets; and then interacting with each system as necessary. For example, the server system may connect 904 to a personnel scheduling system to identify 910 the availability of each necessary person and connect 908 to an asset scheduling system to identify 910 the availability of necessary physical assets.

The server system then correlates 912 the availability of personnel and physical assets and send instructions to the relevant independent system to schedule 914 the necessary personnel and physical assets.

In some embodiments, the server system may also connect 916 to a hospital billing system to record the allocation of assets during the relevant times.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages. The form herein before described being merely an explanatory embodiment thereof, it is the intention of the following claims to encompass and include such changes.

What is claimed is:

1. A computer apparatus comprising:
at least one processor in data communication with a memory storing processor executable code for configuring the at least one processor to:
establish data communication to a plurality of hospital information technology (IT) systems, each corresponding to an IT application;
establish data communication to a plurality of client devices including at least a patient video device and a healthcare provider video device;
receive an instruction to establish a unified workspace based on a primary client device in the plurality of client devices, the unified workspace comprising at least a video stream including the patient video device and the healthcare provider video device and an instance of each IT application;
send an instruction to at least one client computer in the plurality of client devices to establish a corresponding unified workspace comprising at least the video stream and an instance of each IT application;
receive an annotation to the unified workspace from an annotating client device in the plurality of client devices; and
send the annotation to every other client device in the plurality of client devices.

2. The computer apparatus of claim 1, wherein the processor executable code further configures the processor to:
receive an application selection from a client device;
instantiate the selected application within the corresponding unified workspace; and
send an instruction to each of the primary client device to instantiate the selected application.

3. The computer apparatus of claim 2, wherein the processor executable code further configures the processor to:
receive an indication from at least one client device that the selected application is not present;
instantiate a display window in the unified workspace associated with the at least one client; and
render a visual depiction of the selected application in the display window.

4. The computer apparatus of claim 1, wherein the processor executable code further configures the processor to:
establish data communication with a remote computer server associated with a remote healthcare facility;
establish a data channel for one or more remote client devices connected to the remote computer server;
establish data communication with the one or more remote client devices; and
send the unified workspace to the one or more remote client devices.

5. The computer apparatus of claim 1, wherein the processor executable code further configures the processor to:
establish data communication with an electronic medical record associated with a current patient; and
record the annotation the electronic medical record.

6. The computer apparatus of claim 5, wherein the processor executable code further configures the processor to:
establish data communication with a scheduling system in the plurality of IT systems;
identify a healthcare provider next scheduled to interact with a current client associated with the electronic medical record; and
notify the healthcare provider of the annotated medical record.

7. The computer apparatus of claim 1, wherein the processor executable code further configures the processor to:
establish data communication to one or more reference libraries;
populate at least a portion of the unified workspace with educational material from the one or more reference libraries; and
send an instruction to every other client computer in the plurality of client computers to populate each corresponding unified workspace with identical educational material.

8. A method comprising:
establishing data communication to a plurality of hospital information technology (IT) systems, each corresponding to an IT application;
establishing data communication to a plurality of client devices including at least a patient video device and a healthcare provider video device;
receiving an instruction to establish a unified workspace based on a primary client computer in the plurality of client devices, the unified workspace comprising at least a video stream including the patient video device and the healthcare provider video device and an instance of each IT application;
sending an instruction to at least one client computer in the plurality of client devices to establish a corresponding unified workspace comprising at least the video stream and an instance of each IT application;
receiving an annotation to the unified workspace from the at least one client computer in the plurality of client devices; and
sending the annotation to every other client computer in the plurality of client devices.

9. The method of claim 8, further comprising:
identifying an available scribe based on a user identification associated with a client device;
establishing data communication with the scribe client device; and
instructing the scribe to enter at least a description of the annotation into an electronic medical record associated with a current patient.

10. The method of claim 8, further comprising:
receiving an application selection from the primary client device;
instantiating the selected application within the unified workspace; and
sending an instruction to each of the plurality of client devices to instantiate the selected application.

11. The method of claim 10, further comprising:
receiving an indication from at least one client device that the selected application is not present;
instantiating a display window in the unified workspace associated with the at least one client; and
rendering a visual depiction of the selected application in the display window.

12. The method of claim 8, further comprising:
establishing data communication with a remote computer server associated with a remote healthcare facility;
establishing a data channel for one or more remote client devices connected to the remote computer server;
establishing data communication with the one or more remote client devices; and
sending the unified workspace to the one or more remote client devices.

13. The method of claim 8, further comprising:
establishing data communication with an electronic medical record associated with a current patient; and
recording the annotation the electronic medical record.

14. The method of claim 13, further comprising:
establishing data communication with a scheduling system in the plurality of IT systems;
identifying a healthcare provider next scheduled to interact with a current client associated with the electronic medical record; and
notifying the healthcare provider of the annotated medical record.

15. The method of claim 8, further comprising:
recording a connection time for each client device in the plurality of client devices;
establishing data communication with a billing system in the plurality of IT systems; and
instructing the billing system to record the connection time corresponding to a healthcare provider for a current patient.

16. A system comprising:
a plurality of client devices including at least a patient video device and a healthcare provider video device, each configured to communicate with a server;
one or more patient monitoring devices;
a server in data communication with the plurality of client devices and the one or more patient monitoring devices, the server configured to:
establish data communication to one or more hospital information technology (IT) systems, each corresponding to an IT application;
establish data communication to the plurality of client devices;
establish data communication to a plurality of client computers;
receive an instruction to establish a unified workspace based on a primary client computer, the unified workspace comprising at least a video stream including the patient video device and the healthcare provider video device and an instance of each IT application;
send an instruction to every other client computer in the plurality of client computers to establish a corresponding unified workspace comprising at least the video stream including the patient video device and the healthcare provider video device and an instance of each IT application;
send an instruction to every other client computer in the plurality of client computers to configure the instance of each IT application in the corresponding unified workspace identically to the instance on the primary client computer;
receive an annotation to the unified workspace from a client computer; and
send the annotation to every other client computer for rendering in the corresponding unified workspace.

17. The system of claim 16, wherein the server is further configured to establish a secure data socket to allow wireless data communication with one or more remote client devices.

18. The system of claim 16, wherein the server is further configured to:
identify an available scribe based on a user identification associated with a client device;
establish data communication with the scribe client device; and
instruct the scribe to enter at least a description of the annotation into an electronic medical record associated with a current patient.

19. The system of claim 16, wherein the server is further configured to:
record audio streams between the plurality of client devices;
transcribe the audio streams via voice recognition;
establish data communication with an electronic medical record in the plurality of IT systems corresponding to a current patient; and
record the transcriptions in the electronic medical records.

20. The system of claim 16, wherein the server is further configured to:
establish data communication to one or more reference libraries;
populate at least a portion of the unified workspace with educational material from the one or more reference libraries; and
send an instruction to every other client computer in the plurality of client computers to populate each corresponding unified workspace with identical educational material.
